(19) United States
(12) Patent Application Publication
(10) Pub. No.: US 2014/0321714 A1
(43) Pub. Date: Oct. 30, 2014

(54) Methods of enhancing agricultural production using spectral and/or spatial fingerprints

(71) Applicant: Billy R. Masten, Shallowater, TX (US)

(72) Inventor: Billy R. Masten, Shallowater, TX (US)

(21) Appl. No.: 13/986,375

(22) Filed: Apr. 24, 2013

(51) Int. Cl. G06K 9/00

(52) U.S. Cl. CPC G06K 9/00657
USPC 382/110

(57) ABSTRACT

These inventions are directed to methods and devices for enhancing agricultural production using low cost digital electronic spectral and/spatial analysis to determine the shortage of one or more nutrients. The preferred method is to take a spectral image of a healthy plant known to have a sufficient amount of the nutrient in question to form a “standard of comparison” and placing same in a digital memory, then taking a spectral image of a plant whose sufficiency of the nutrient is in question and comparing the coefficient of correlation of the two images at a plurality of points along short segments of the images to identify the nanometer range in which the correlation of coefficient is small to identify the nutrient in questions. Thereafter, the shortage of the specific nutrient in question can be ascertained by subsequent comparisons of field crops by looking at the specific nanometer range identified for the specific nutrient.

### CLAIM OF PRIORITY

This application claims the benefit of the prior provisional application entitled Methods of Enhancing Agricultural Production Using Spectral and/or Spatial Fingerprints, filed Apr. 27, 2012 as U.S. Provisional Application No. 61/687,605.

### FIELD OF INVENTION

These inventions are directed to methods and devices for enhancing agricultural production using low cost digital electronic spectral and/spatial analysis. More specifically, these inventions comprise methods and electronically programmed digital electronic devices to objectively identify plant nutrient needs such as water, nitrogen, phosphates, potassium, calcium, sulfur, zinc, and magnesium. These inventions also include methods of determining the specific date or range of dates of application of these nutrients that will maximize yield. And finally, these inventions will also permit integration with linear equations to determine the least cost or the most profitable application of such nutrients.

### THE PRIOR ART

The known prior art comprises four patents that are assigned to Masten Opto-Diagnostic Company, LLC of Lubbock, Tex., a company to which the inventions of this application are also assigned. Those patents are U.S. Pat. No. 6,919,959 issued Jul. 19, 2005, U.S. Pat. No. 7,099,004 issued Aug. 29, 2006, U.S. Pat. No. 7,362,423 issued Apr. 22, 2008 and U.S. Pat. No. 7,417,731 issued Aug. 26, 2008 each of which is incorporated by references as if fully set forth herein.

These patents disclose spectral imaging of plants and substances for the purposes of identification of the plants by species together with identification of some plant conditions and other information with the disclosed hand held, low cost spectrometer disclosed therein. Identification of plants and their conditions can be performed by a central processor, preferably a Digital Signal Processor, that is programmed with mathematical algorithms capable of comparing a digital spectral image of a plant with a “standard” digital image previously acquired and held in memory for purposes of identification. In addition, these patents disclose the alternative of transmitting the spectral image to a readable electronic memory of a computer or other device for subsequent analysis and identification of the physical condition of the object at a remote site.

Additional prior art is found in research papers that have concluded that spectral imaging can detect plant moisture and nutrient needs. For example, a research paper developed by researchers of Purdue University entitled “Spectral Characteristics of Normal and Nutrient Deficient Maize Leaves” dated August 1972 and further identified as NTIS Order No. N73-+16065 concludes “spectral detection of nutrient-deficient plants is possible by remote sensing techniques.

In spite of these technical papers and the prior development of the inventions of the Masten patents, the art has not, to applicant's knowledge, developed low cost commercial methods and devices that are effective to identify plant specific nutrient needs on a local basis that are useful to the individual farmer or that will enhance the farmer's plant yields, maximize crop production, reduce costs and/or maximize profits. Indeed, there is no known commercial method or low cost device that can provide objective identification of plant needs for water, and nutrients. As a result, the American farmer continues to rely on visual observation, subjective judgments and his personal experiences to determine when plant nutrients and fertilizers should be added to enhance yields, minimize costs or maximize profits. Similarly, institutions lending money to farms to support these crops and national forecasting services continue to rely upon personal, non-objective evaluations to lend money and to forecast national yields.

In part, this lack of progress is believed to result from the lack development of spectral fingerprints (images) and effective, low cost mathematical concepts and digital algorithms to identify diseases, to provide objective standards for the application of plant nutrients (micronutrients and macronutrients) and to decide on the beneficial effect for the application of water by sprinkler or other irrigation means at specific times. This lack of progress is also believed to result from the lack of an appropriate concepts and business methods for its implementation. Accordingly, the present inventions and this patent application are directed to the immediate implementation and development of devices and methods for the enhancement of agricultural productions, yields and profits.

### SUMMARY OF INVENTIONS

The preferred embodiments of these inventions are primarily directed to concepts for enhancing crop production, minimizing costs and maximizing profits. Preferably, such inventions utilize, in large part, the prior low cost Masten spectroscopic inventions (identified above) having a microprocessor such as a Digital Signal Processor to gather the images of a plant of a farm crop, to perform a novel math analysis on said image and to immediately display the conclusion as to whether the plants have one or more nutrient and/or moisture shortages. Alternatively, the spectroscopic inventions of the above patents can be used to obtain a digital spectral image and to transmit same to a remote computer for analysis and determination as to whether the plant has one or more nutrient and/or moisture shortages. Enhancement of agricultural crops results from the further communication of crop recommendations back to the farmer. A preferred pre-requisite to the implementation of such procedures, is the development of a repository having baseline digital images that identify plants with adequate nutrients and moisture conditions. Accordingly, the goals and objectives of this invention are to provide, among other things:

1) methods and devices for accurately ascertaining whether a farm crop, orchard plant, golf course, etc., are in need of nutrients and or moisture;

2) methods and devices for utilizing such digital images to accurately and objectively provide the agricultural profession with early advices as to plant needs—needs that are difficult if not impossible to be identified through human visual observation;

3) methods of utilizing such digital images to provide the agricultural profession with the earlier, timely, and accurate recommendations for the application of specific nutrients and or irrigations needs of agricultural crops;

4) methods of using spectral analysis to determine the least cost alternatives for crop production; and

5) methods of using spectral analysis to plan for the maximum profitability of crop production.

### DESCRIPTION OF THE DRAWINGS

The manner in which these objectives and other desirable characteristics can be obtained from this invention is explained in the following specification and attached drawing in which:

FIG. 1 is an illustrative graphical presentation of a digital spectral image of healthy corn plant labeled A; a digital image of field corn plant that has a shortage of nitrogen labeled B, and a plot of the regression coefficient of A and B which is labeled C depicting the inventor's concept of objectively determining the shortage or lack of nitrogen of corn plant;

FIG. 2 is an illustrative graphical presentation of a digital spectral image of a healthy bean plant labeled A, a bean grown without any additional nitrogen labeled B, and a plot of the regression coefficient of A and B which is labeled C depicting the inventor's concept of objectively determining the shortage or lack of nitrogen of the bean plant.

FIG. 3 is an illustrative graphical presentation of a digital spectral image of a healthy pepper plant which is labeled A, a pepper plant that is believed to be short of moisture which is labeled B and a plot of the regression coefficients of A and B depicting the inventor's concept of objectively determining a shortage of or lack of moisture in the pepper plant.

FIG. 4 is a block diagram depicting a low cost spectral and/or spatial analyzer made according the prior disclosures of the Masten patents identified earlier, but modifying and incorporating algorithms and a display unit for displaying to the user the results of the analysis of a plant's need or lack of need for nutrients and/or moisture.

FIG. 5 is a chart depicting a method of experimental analysis to determine the preferred dates on which to apply nutrients to maximize yield.

### DETAIL DESCRIPTION

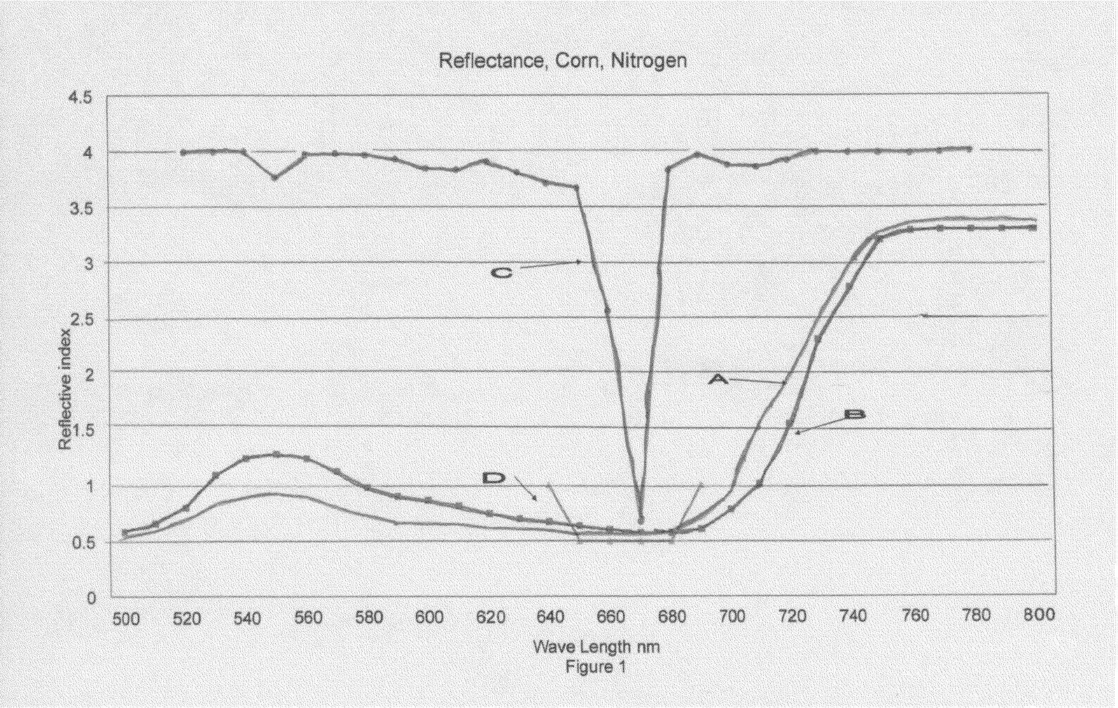

The manner in which the foregoing goals and objectives can be obtained is depicted in the above identified drawings and in the following detail description of the preferred embodiments. Referring first to FIG. 1, such depicts graphical plots of data points of two digital spectral images of corn leaves in which the spectral images extend from about 500 nanometers to about 800 nanometers (horizontal axis) and the vertical axis is a relative measure of the reflectivity of the plant. The first plot represents a digital image A, colored green, of a corn plant that is known to have an adequate supply of the nutrient nitrogen because this nutrient was routinely added to its soil. The second plot is a digital image B, colored blue, of a corn plant whose sufficiency of nitrogen is unknown.

In looking at and visually comparing the digital images of the two different corn plants, only minor differences are noted and the two appear quite similar. Indeed, a regression analysis of the data underlying the two graphs results in a high correlation between the two and such an analysis does not appear to be informative. Indeed, the similarity between the graphs does not suggest the possibility of obtaining useful information.

However, by further efforts to evaluate and isolate the need for nitrogen in the plant of the second plot, this inventor has discovered that a regression analysis, if run on segments or sectors of the data underlying the graphs, even though it involves fewer data points, can be very informative. For example, by selectively performing a regression analysis over a plurality of sectors of some fifty 50 nanometers, it turns out that the correlation of coefficient of sectors of the two graphs are very similar and approach the number 1 for the majority of the data points. However, when the coefficients of these plural regressions are plotted in red as shown at C, such reveals a very substantial difference in the two graphs. This substantial difference occurs in the region of 650 and 700 nanometers. Indeed, in this narrower sector, the coefficient of correlation drops from approximately 99 down to approximately 0.016 as reflected by the top graph C in red. (To avoid confusion and to assist in the visual distinction between the two graphs, the coefficient of correlation thus determined has been multiplied by four (4) prior to graphing). And clearly, a visual comparison of the two graphs across the entire span 500-800 nanometers prior to this segmental regression gave no hint of this substantial difference in the two graphs.

In as much as the only known difference between the two plants is that of the supply of nitrogen, it is concluded that the field plant is short of nitrogen.

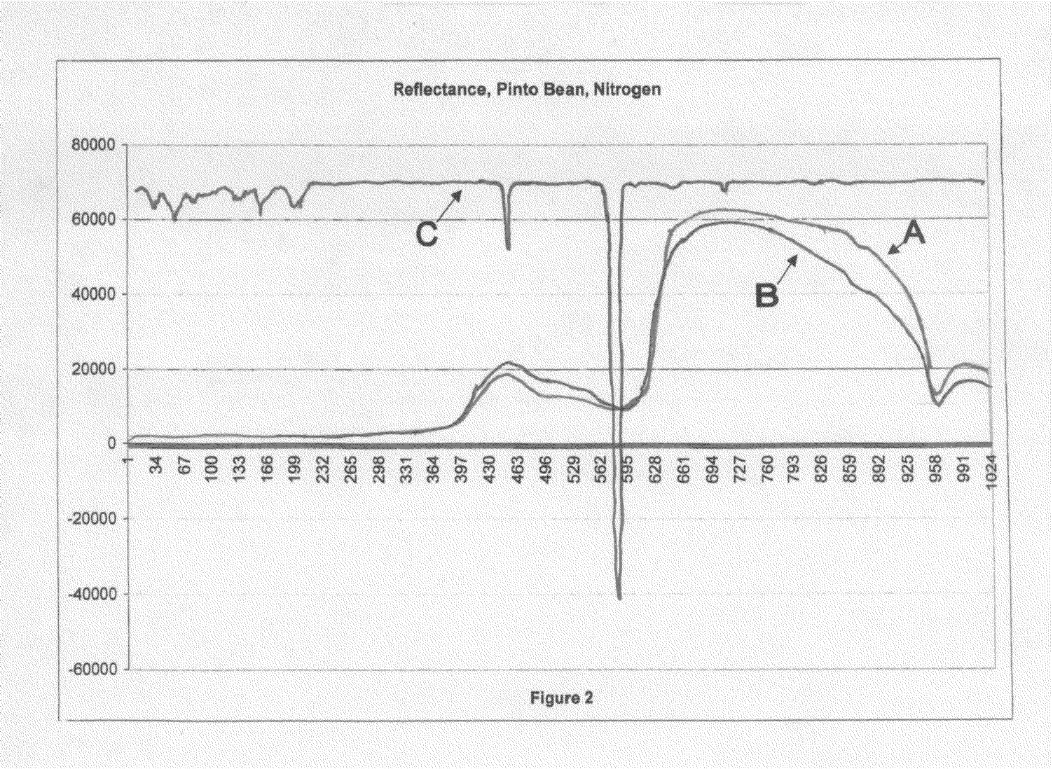

Another comparison was made of bean plants in which one was provided with sufficient nitrogen and another plant that had no added nitrogen. The results are shown in FIG. 2. The green curve A is a digital spectral image of the healthy plant to which additional nitrogen has been provided and the blue curve B is a digital spectral image of the field bean plant. And again, there is no apparent, substantial difference between the two curves and a regression analysis of the two curves results in a coefficient of correlation that is very high. Moreover, the differences between two curves gives no strong hint of any shortage of nitrogen.

Yet, when a plurality of regression analysis are made on sequential sectors of the graphs and plotted in red (curve C), one finds a very substantial change in the coefficients of regression in the sector from 650 nanometers and 700 nanometers. And again, when one visually compares the spectroscopic images of the two bean plans, one finds nothing that indicates a shortage of nitrogen.

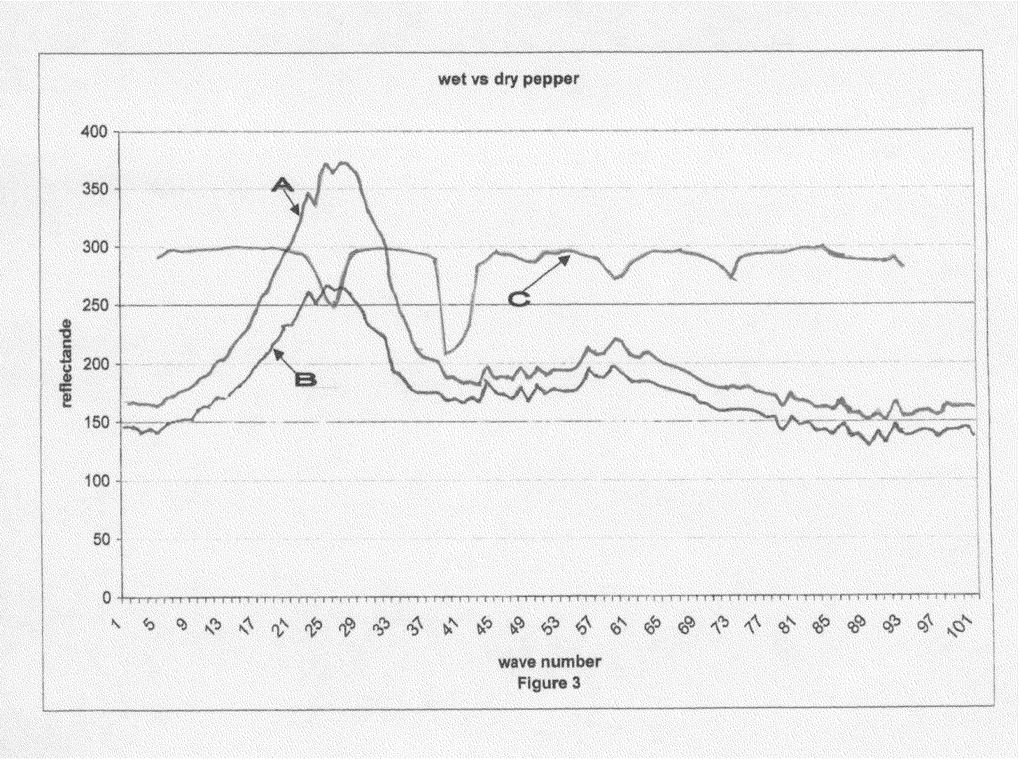

FIG. 3 contains spectral graphs of a pepper plant with sufficient moisture A, a field pepper plant that is believed to be short of moisture B and the graph of the coefficients of correlation of numerous sectors of the two graphs C. In as much as the only known difference in the plants, is the difference in moisture, the two substantial dips in the red curve is attributed to a lack of moisture in the field plant. (As in the prior graphs, the vertical axis of FIG. 3 represents the degree of reflectivity, but the horizontal axis reflects the information obtained from numbered pixels of the spectroscopic device rather than the actual wave lengths).

On belief, the need for and the desirability of adding additional nutrients such as phosphates, sulfur, zinc, etc. to a farm crop can also be determined in a similar manner, i.e., comparing digital data points underlying digital images of a plant known to have a sufficient amount of the nutrient in question and a plant whose sufficiency of that nutrient is unknown.

In sum and substance, a shortage of a nutrient can be determined by comparing the digital image of a plant known to have a sufficient quantity of that nutrient available with the digital image of a farm plant whose shortages are unknown. Consequently, for a farmer who desires to always keep a plant satisfied, the foregoing comparative analysis will be very useful. Upon a determination of any shortage, such can be immediately applied by fertilizer rigs, thru moisture distribution, etc.

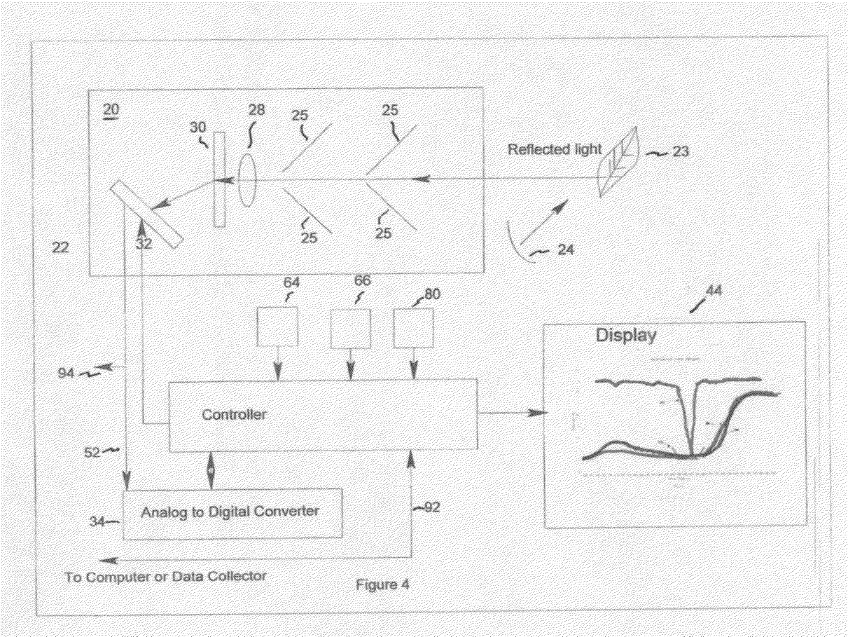

FIG. 4 depicts a low cost device for taking the above described images of the plant, for comparing the digital images, and for making and displaying the digital images. This device is a modification of the spectroscopic devices shown in the prior listed Masten patents. As suggested by those patents, such a unit is unit is encapsulated in a hand held body that may take the size and configuration of a flashlight or other small, handheld machine vision device (not shown) and such is intended to be easily portable. This device has an identifier 20 for taking a spectral image of a leaf of a plant species such as corn leaf 23 that is known to be supplied with sufficient nutrients and/or moisture, the plant being illuminated by a lamp 24, if necessary. This image is directed through side plates 25 which form slits or vertical apertures in housing 22 to insure that the light is directed through a lens 28 having a focal length, preferably of 1 inch, to a diffraction grating 30. Preferably the diffraction grating has 1,000 lines per meter. This grating 30 breaks the reflected light into discrete wavelengths and directs it to a linear or area array of pixels of a sensing unit 32. Those skilled in the art will appreciate that a prism may be an adequate substitute for the diffraction grating.

In operation, each of the pixels of the sensing unit develops a voltage that correlates to the quantity of light received across several consecutive nanometers. This voltage developed by each pixel can be read by the controller 36 which has a switch 64 to enable the user to manually instruct the unit to pulse the sensor array 32 to obtain spectral distribution of the “sample” or “standard” of a plant known to have sufficient nutrients of interest. This pulse signal will sequentially generate an analog output from all of these pixels to the sensor array 32 and transmit them to an analog-to-digital converter 34. The converter 34 will then direct digital information corresponding to the magnitude of the voltage developed by each pixel into a first set of memory elements of the micro controller 36 which, preferably, is a Digital Signal Processor. Alternatively, the digital information of this spectral image can be transferred into memory elements of a separate memory unit element for storage and comparison purposes.

When stored (memorized), the micro controller 36 then has a spectral distribution or “fingerprint” of the wavelengths reflected by the fully fertilized plant that is to be compared with the spectral fingerprints of a plant in the field whose available nutrients are to be ascertained. This memorized digital image or fingerprint thus becomes the “standard” against which subsequent images or fingerprints are to be compared to ascertain nutrient and or moisture shortages.

The spectral distribution of the plant can also be transmitted to other computers or hand held devices via a serial communication port 96 micro controller so as to form a library of a well-nourished nitrogen plant for the local farm area.

After obtaining a standard fingerprint of a well-nourished corn plant, the unit is ported to a farmer's field of corn where a second spectral image is taken of the leaf of a plant in the field by pointing the device to a leaf of the plant and actuating a second switch 66. This second spectral image is also converted to a digital image and stored in another portion of the memory or in a connected memory.

Preferably and prior to taking any images, the controller or DSP 36 is programmed with an algorithm that, serially accesses each segment or group of data points of the spectral image of both plants, preferably in a segment size that corresponds to approximately 50 nanometers and computes a coefficient of correlation of each 50 nanometer sector of each of the two graphs. This operation may be actuated by pressing switch 80.

The Controller is also programmed to transmit the output of the coefficient of correlation of each sector to visual display device 44. Preferably, the display unit is programmed to display both the spectral images of each plant together with the actual values of the coefficient of correlation. In addition, the display should be programmed to depict graphs as illustrated in FIGS. 1, 2 and 3.

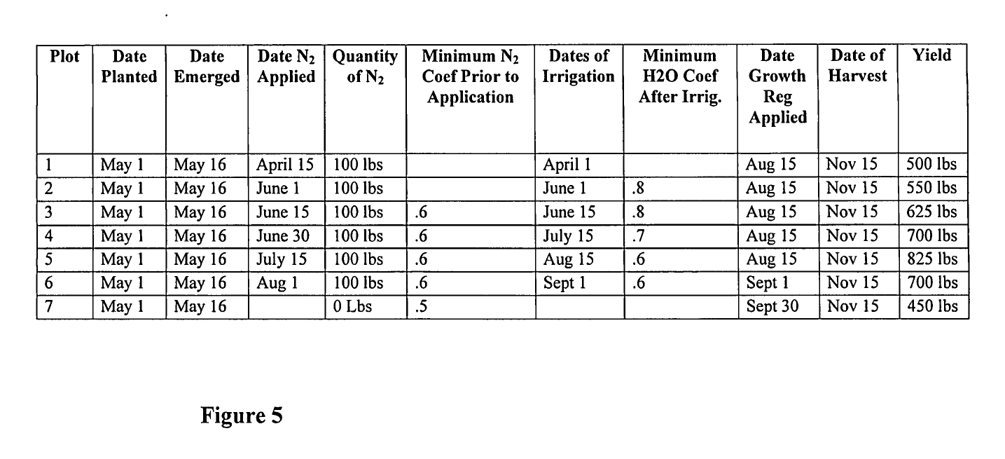

Many farmers and individuals managing orchids, golf greens and other living plants often believe that a shortage of some nutrients and/or moisture may be temporarily beneficial to a plant. Moreover, few seem to know for sure when nutrients, growth regulating chemicals (growth regulators) and or moisture should be applied to plants to achieve maximum yields. Similarly, it may be that the application of moisture to grapes at a specific time during the growing season will result in the highest, most desirable sugar level of the fruit. To facilitate such determinations, Applicants' inventions may be used experimentally to determine such results. For example, assume that cotton is planted in West Texas on May 1 and it emerges, after a rain on May 16. By dividing the field into different plots, and by applying a single or a combination of nutrients, growth regulators and/or moisture to the different plots on different days after a significant date (planting date or emergent date), one can track the coefficient of correlation of each nutrient, the days on which a given nutrient was short or adequate, and then, after measuring the yield and/or quality (micronaire reading of cotton, sugar level of grapes, etc.) of the harvested product, determine the best dates on which to supply such nutrients, or growth regulators. Such a representative evaluation is depicted in FIG. 5 relating to Bayer Cottonseed,

Those skilled in the art will appreciate that numerous devices can be utilized to provide the spectral images, that they can be transmitted to large computers having a centralized library of excellent specimens of well-nourished plants and that such computers can run the desired regression analysis—and inform the farmer of his plants needs on a weekly or daily basis. Alternatively, the low cost Masten spectrometers having the very fast DSP's will provide farmers with an immediate answer. Those skilled in the art will also appreciate that numerous other combinations of imagers, I Pads, etc. can be adapted to perform some or all of the functions in an excellent matter. Similarly, person skilled in the arts of spectrometers, computers, imagers and mathematical functions will well appreciate that different algorithms, visual studies and comparative methods may be used to evaluate the difference between the plots of good and unknown plants of the same species

Those skilled in the various arts will also appreciate that the present inventions have very broad uses in agricultural operations as well as in government crop forecasting, etc. From this application, many additional applications will be apparent to those skilled in the art. For example, the spatial application mentioned above, when used in combination with the spectral imager can be used to count cotton bolls in the field at various times, to assess the effect of dry weather as the plants prematurely drop those bolls, and to estimate the final yield of a cotton field. Another very helpful application would be to track the yields of plants to which different quantities of fertilizer is applied and then to develop linear equations to calculate the minimum costs of different levels of fertilizers or to calculate the maximum profits to be derived from the plants. Such techniques are well discussed under the topic “linear programming” in basic textbooks such as “Cost Accounting, A Managerial Emphasis” authored by Charles T. Horngren of Stanford University and published by Prentiss Hall, now in its thirteenth Edition.

I claim:

1. A method of determining a shortage in an agricultural plant nutrient, said method comprising:
a) taking a digital spectral image of an agricultural plant species that is known to have sufficient quantity of the nutrient in question;
b) taking a digital spectral image of the same agricultural plant species during the crop production year;
c) calculating the correlation coefficient between the two digital images of groups of plurality of adjacent points on the two images;
d) identifying the nanometer range of the digital spectral image of which the coefficient of correlation is the smallest, said identified range reflecting the shortage, if any, of the nutrient in question.

2. A method as recited in claim 1 in which the identified range is, or can be associated with a specific nutrient.

3. A method as recited in claim 1 in which the nutrient in question is selected from the following group of nutrients: phosphates, nitrogen, sulfur, water, and potassium.

4. A method as recited in claim 2 in which said spectral image is extends from about 500 nanometers to about 800 nanometers.

5. A method as recited in claim 1 in which said images are taken by a portable spectrometer and transmitted to a laboratory computer for making said identification.

6. A portable spectrometer device for determining the shortage of a plant nutrient desirable for maximum yield of the agricultural plant, said apparatus comprising:
a) a sensing unit having an imager and a first associated memory containing a standard spectral image of a species of plant having a known sufficiency of at least one nutrient;
b) a sensing unit for obtaining a spectral image in a second memory space for obtaining a second digital image of the same plant species at one or more times during the agricultural crop year;
c) a digital identifier having an algorithm for computing the coefficient of correlation of points a plurality of segments of wavelengths on said digital images;
d) said algorithm providing an output of said coefficient correlations in numerical format to facilitate the differences in said image.

7. A device as recited in claim 6 in which said identified nutrients are from the following group: nitrogen, sulfur, phosphate, potassium and water.

8. A device as recited in claim 6 is which said segments are about 50 nanometers.

9. A method of enhancing agricultural production, yield, and/or profits of a farmer comprising the steps of
a) collecting digital images of plants at time intervals from plants of a growing crop during the plant's growing season;
b) comparing said digital images with a standard digital image in which the plant has a known sufficiency of at least one nutrient;
c) ascertaining if the plant has a shortage of said nutrient by comparing said digital images;
d) applying additional amounts of said nutrient to said crop in known quantities at different dates; and
e) measuring the yield of said plant crop to determine the cost effective time to apply nutrients.

10. A method as recited in claim 1 in which said crop plant is cotton.
